(19) United States
(12) Patent Application Publication
(10) Pub. No.: US 2015/0365127 A1
(43) Pub. Date: Dec. 17, 2015

(54) RF MODULE

(71) Applicant: LG INNOTEK CO., LTD., Seoul (KR)

(72) Inventor: Yu Seon KIM, Seoul (KR)

(21) Appl. No.: 14/726,502

(22) Filed: May 30, 2015

(30) Foreign Application Priority Data
Jun. 11, 2014 (KR) 10-2014-0070530

(51) Int. Cl. H04B 1/525; H04L 25/02; H04B 1/48

(52) U.S. Cl. CPC H04B 1/525; H04B 1/48; H04L 25/0278; H04B 2001/485

(57) ABSTRACT

An RF module includes a first FEM configured to bypass a signal in a first band, and to block a signal in a second band; and a second FEM configured to block a signal in a first band, and to bypass a signal in a second band.

### CROSS REFERENCE TO RELATED APPLICATION

The present application is based on, and claims priority from the Korean Patent Application Number 10-2014-0070530, filed on Jun. 11, 2014, the disclosure of which is incorporated by reference herein in its entirety.

### BACKGROUND

1. Field of the Disclosure

The present disclosure relates of an RF (Radio Frequency) module.

2. Discussion of the Related Art

In general, an RF module, which is configured to receive an RF (Radio Frequency) signal having frequencies in at least two bands, electrically separates a path of an RF signal corresponding to a frequency in a different band, by arranging a diplexer at a latter end of an antenna thereof.

However, matching circuits provided between such components may increase path loss of the RF module, due to transmission lines connected between the matching circuits. Thus, there occurs a problem that the received power is lost, or the sensitivity of transmission signal declines.

In addition, there are still other problems that the process cost may increase due to integration of components, and the size of the RF module also may become larger. Furthermore, EMI (Electro-Magnetic Interference) occurring due to interference between components may not be controllable.

In addition, efficiency of the diplexer may decline due to phase shift of the matching circuit in the transmission line. Therefore, there is also a risk that the receive characteristics may not be maintained in a load.

### SUMMARY OF THE DISCLOSURE

One technical challenge that the present disclosure is to achieve is, to miniaturize the RF module by eliminating the diplexer and the matching circuit so as to reduce the length of a total path, and to provide an RF module in which interference between components is eliminated.

In order to achieve the challenge, in a general aspect of the present disclosure, there is provided an RF module, the RF module comprising: a first FEM (Front-End Module) configured to bypass a signal in a first band, and to block a signal in a second band; and a second FEM configured to block a signal in a first band, and to bypass a signal in a second band.

In some exemplary embodiments of the present disclosure, the first FEM may transmit the signal in the first band received from an antenna to a first load, and may transmit the signal in the first band received from the first load to an antenna, and the second FEM may transmit the signal in the second band received from the antenna to a second load, and may transmit the signal in the second band received from the second load to the antenna.

In some exemplary embodiments of the present disclosure, the first FEM may be designed as to resonate with respect to the signal in the first band, and to have an infinite impedance with respect to the signal in the second band.

In some exemplary embodiments of the present disclosure, a value of a reflection coefficient of the first FEM may be determined between 0.9 and 1, and a phase of the reflection coefficient of the first FEM may be determined between minus 50 degree and plus 30 degree.

In some exemplary embodiments of the present disclosure, the first FEM may have an impedance determined so as to match an impedance of the first load with an impedance of the antenna in the first band.

In some exemplary embodiments of the present disclosure, the second FEM may be designed as to resonate with respect to the signal in the second band, and to have an infinite impedance with respect to the signal in the first band.

In some exemplary embodiments of the present disclosure, a value of a reflection coefficient of the second FEM is determined between 0.9 and 1, and a phase of the reflection coefficient of the second FEM is determined between minus 50 degree and plus 30 degree.

In some exemplary embodiments of the present disclosure, the second FEM may have an impedance determined so as to match an impedance of the second load and an impedance of the antenna in the second band.

In some exemplary embodiments of the present disclosure, at least one of the first and the second FEMs may be an SPDT (Single-Pole Double-Throw) switch configured to separate a transmission signal and a reception signal.

In some exemplary embodiments of the present disclosure, at least one of the first and the second FEMs may be a duplexer configured to electrically separate a transmission signal and a reception signal.

In some exemplary embodiments of the present disclosure, at least one of the first and the second FEMs may be an element configured to perform an ON/OFF function with respect to a transmission signal, and to perform an LNA (Low Noise Amplifier) function with respect to a reception signal.

In some exemplary embodiments of the present disclosure, at least one of the first and the second FEMs may be an element configured to perform an ON/OFF function and an amplification function with respect to a transmission signal, and to perform an LNA function with respect to a reception signal.

In some exemplary embodiments of the present disclosure, the RF module may further comprise: a first matching circuit configured to match an impedance of the antenna and an impedance of the first FEM; and a second matching circuit configured to match an impedance of the antenna and an impedance of the second FEM.

In some exemplary embodiments of the present disclosure, each of the first and the second matching circuit may be any one of an LPF (Low Pass Filter), an HPF (high pass filter), a BPF (Band Pass Filter), or a BSF (Band Stop Filter), respectively.

In another general aspect of the present disclosure, there is provided an RF transmitter/receiver, the RF transmitter/receiver comprising: an antenna configured to receive signals in at least two bands; and an RF module configured to transmit the signals in at least two bands received from the antenna to at least two loads, respectively, wherein the RF module includes at least two FEMs configured to bypass any one of the signals in at least two bands and to block other signals in remaining bands.

In some exemplary embodiments of the present disclosure, the RF module may include at least two matching circuits configured to match an impedance of the antenna and an impedance of each of the at least two FEMs, respectively.

In still another general aspect of the present disclosure, there is provided a MIMO (Multiple-Input, Multiple-Output), the MIMO system comprising: a plurality of antennas configured to receive signals in two bands, respectively; and a plurality of RF modules configured to transmit the signals in two bands respectively received from the plurality of antennas to two loads, respectively, wherein each of the plurality of RF modules respectively includes: a first FEM configured to bypass a signal in a first band, and to block a signal in a second band; and a second FEM configured to block a signal in a first band, and to bypass a signal in a second band.

According to an exemplary embodiment of the present disclosure, an advantageous effect may be obtained in that entire circuits of the RF module may be simplified and miniaturized, as well as the cost of the whole module may be reduced, by eliminating the diplexer from the RF module at an RF transmit/receive terminal and by eliminating the matching circuits between the antenna and the diplexer and between the diplexer and the FEMs

In addition, according to an exemplary embodiment of the present disclosure, there is another advantageous effect that the total path loss can be reduced, by eliminating the diplexer from the RF module at an RE transmit/receive terminal so as to eliminate loss at the diplexer and the matching circuit.

### BRIEF DESCRIPTION OF THE DRAWINGS

FIG. 1 is a block diagram illustrating a conventional RF module.

FIG. 2 is a conceptual block diagram illustrating an RF module according to an exemplary embodiment of the present disclosure.

FIG. 3 is a Smith chart describing a reflection coefficient of an FEM (Front-End Module).

FIG. 4 is a conceptual block diagram illustrating an RF module according to another exemplary embodiment of the present disclosure.

FIGS. 5A and 5B are exemplary views describing implementation characteristics of the present disclosure.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, the described aspect is intended to embrace all such alterations, modifications, variations, and equivalents that fall within the scope and novel idea of the present disclosure.

While terms including ordinal numbers, such as “first” and “second,” etc., may be used to describe various components, such components are not limited to the above terms. The above terms are used only to distinguish one component from another.

When a component is mentioned to be “connected” to or “accessing” another component, this may mean that it is directly connected to or accessing the other component, but it is to be understood that another component may exist in-between. On the other hand, when a component is mentioned to be “directly connected” to or “directly accessing” another component, it is to be understood that there are no other components in-between.

Hereinafter, referring to accompanying drawings, an exemplary embodiment according to the present disclosure will be described in detail.

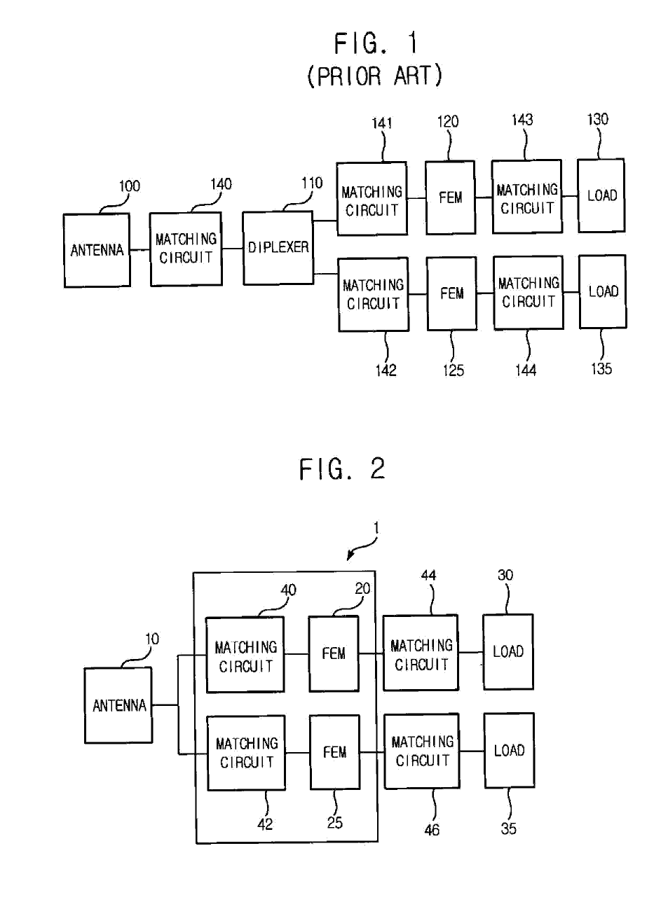

FIG. 1 is a block diagram illustrating a conventional RF module.

As illustrated in FIG. 1, a conventional RF module, which is provided at a transmit/receive terminal transmitting/receiving signals in different frequency bands, includes a diplexer (110). The conventional RF module separate signals in different frequency bands received from an antenna (100), respectively transmits the separated signals to FEMs (Front-End Modules) (120, 125). Then, the signals are delivered to loads (130,135) through the FEMs (120, 125).

Here, a plurality of matching circuits (140˜144) are respectively provided between each of the components, in order to minimize reflection loss between each of the components. That is, the matching circuit (140) provided between the antenna (100) and the diplexer (110) reduces reflection loss between the antenna (100) and the diplexer (110), and the matching circuits (141, 142) respectively provided between the diplexer (110) and the FEMs (120, 125) reduces reflection loss between the diplexer (110) and the FEMs (120, 125), respectively. In addition, the matching circuits (143, 144) respectively provided between the FEMs (120, 125) and the loads (130, 135) reduces refection loss between the FEMs (120, 125) and the loads (130, 135), respectively. In addition, such matching circuits (140˜144 ) and the components are connected by transmission lines.

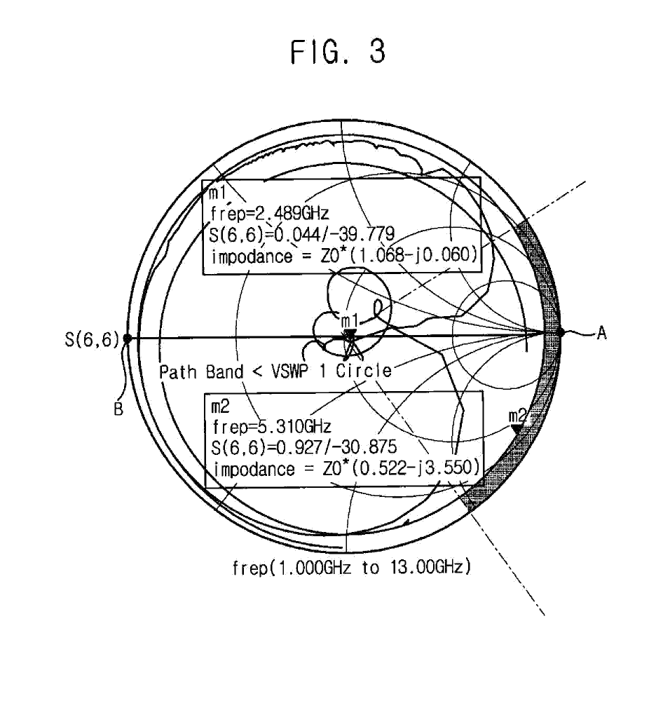

FIG. 2 is a conceptual block diagram illustrating an RF module according to an exemplary embodiment of the present disclosure.

As illustrated in FIG. 2, the RF module (1) according to an exemplary embodiment of the present disclosure may include a first and a second FEM (20, 25) and a first and a second matching circuit (40, 42), in, order to receive signals received through the antenna (10) and provide signals delivered from the loads (30, 35) to the antenna (10). In addition, the first and the second FEM (20, 25) according to an exemplary embodiment of the present disclosure may respectively be connected to the first and the second load (30, 35). A third and a fourth matching circuit (44, 46) may be provided respectively between the first and, the second FEM (20, 25) and the first and the second load (30, 35).

That is, the RF module (1) according to an exemplary embodiment of the present disclosure may provide signals in two frequency bands respectively to the first and the second load (30, 35), or may radiate signals in, two frequency bands provided from the first and the second load (30, 35) through the antenna (10).

The RF module (1) according to an exemplary embodiment of the present disclosure may be provided at the transmit/receive terminal which simultaneously transmits/receives signals in at least two frequency band. Although an example where signals in two frequency bands are transmitted/received is described in an exemplary embodiment of the present disclosure, the scope of the present disclosure is not limited hereto. For example, the RF module (1) according to an exemplary embodiment of the present disclosure may be provided at the transmit/receive terminal which receives a first band signal of 2.4 GHz and a second band signal of 5 GHz. However, the present disclosure is not limited hereto.

The RF module (1) according to an exemplary embodiment of the present disclosure may have a circuit arranged as to have a characteristic of diplexer by itself. That is, the RF module (1) according to an exemplary embodiment of the present disclosure may function as a switch and a diplexer at the same time.

The first FEM (20) according to an exemplary embodiment of the present disclosure may be formed as to resonate with an impedance of 50Ω (based on reflection coefficient of 1) in the first band, and may be formed as to have an infinite impedance in the second band.

Generally, the FEM is an element arranged after the antenna in the transmit/receive terminal. The FEM may be an SPDT (Single-Pole Double-Throw) switch configured to separate a transmission signal and a reception signal. The FEM may be a duplexer configured to electrically separate a transmission signal and a reception signal without using an active element. In addition, the FEM may be an element configured to perform an ON/OFF function with respect to a transmission signal, and to perform an LNA (Low Noise Amplifier) function with respect to a reception signal. The FEM may be an element configured to perform an ON/OFF function as well as an amplification function with respect to a transmission signal, and to perform an LNA (Low Noise Amplifier) function with respect to a reception signal. In addition, the FEM may be a SP3T (Single-Pole Triple-Throw) switch.

It is obvious to those skilled in the art that the type of FEM may be determined according to configuration of loads.

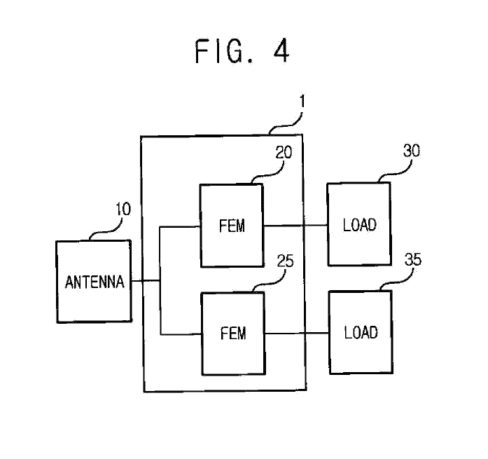

FIG. 3 is a Smith chart describing a reflection coefficient of an FEM (Front-End Module).

In general, a reflection coefficient in a circuit as illustrated in FIG. 2 may be calculated as follows:

$$Γ = \frac{( {Z}_{in} / {Z}_{ant} - 1 )}{( {Z}_{in} / {Z}_{ant} + 1 )} \qquad [ Equation 1 ]$$

where Γ is a reflection coefficient of a first or a second FEM (20, 25), Zin is an input impedance of a first or a second FEM (20, 25), and Zant is an impedance of an antenna (10).

The first FEM (20) may be designed as to resonate with an impedance of 50Ω (based on reflection coefficient of 1) with respect to the signal in the first band, and to have an infinite impedance (that is, opened) with respect to the signal in the second band. Here, the time constant may be designed so that a magnitude of a reflection coefficient of the first FEM (20) is determined between 0.9 and 1, and a phase of the reflection coefficient of the first FEM (20) is located between minus 50 degree and plus 30 degree.

That is, the reflection coefficient of the first FEM (20) in the second band may be determined as to be arranged within the shadow region of the Smith chart illustrated in FIG. 3.

Referring to FIG. 3, a point where the phase of reflection coefficient is 0 and the magnitude of reflection coefficient is 1 (point ‘A’) is an ideal open point. Little branch loss occurs where the phase of reflection coefficient is between −5 degree and 5 degree. The branch loss may be reduced as approaching the ideal point. According to an experiment, the branch loss increases by about 0.1 dB, as the phase deviates from the ideal point by 10 degrees. The substitution effect of a diplexer disappears when a branch loss more than 0.5 dB occurs whereby the reflective coefficient deviates from a predetermined figure (that is, wherein a magnitude of reflection coefficient is between 0.9 and 1, and a phase of reflection coefficient, is between minus 50 degree and plus 30 degree). Meanwhile, in FIG. 3, the point where the phase of reflection coefficient is 180 degree and the magnitude of reflection coefficient is 1 (point ‘B’) is a short point. About −10 dB of electric power branch loss occurs when the reflection coefficient is located near at the short point in a stopband.

Meanwhile, the second FEM (25) may be designed as to resonate with an impedance of 50Ω (based on reflection coefficient of 1) with respect to the signal in the second band, and to have an infinite impedance (that is, to be opened) with respect to the signal in the first band. Here, the time constant may be designed so that a magnitude of a reflection coefficient of the second FEM is determined between 0.9 and 1, and a phase of the reflection coefficient of the second FEM is located between minus 50 degree and plus 30 degree. That is, the reflection coefficient of the second FEM (20) in the first band may also be determined as to be arranged within the shadow region of the Smith chart illustrated in FIG. 3.

That is, the FEMs (20, 25) according to an exemplary embodiment of the present disclosure may be designed so that the impedance of the whole of all paths is designed as to match an impedance of the loads (30, 35) with an impedance of the antenna (10) in the passband and the adjacent band thereof, and may be designed so that the impedance of the whole of all paths becomes infinite (that is, to be opened) in the stopband and the adjacent band thereof.

For example, a case of, an RF module(1) which delivers a first band signal of 2.4 GHz to a first load (30) through a first FEM (20) and delivers a second band signal of 5 GHz to a second load (35) through a second FEM (25) (and vice versa) will be described hereinafter.

The first FEM (20) may be designed so that the impedance (50Ω) is determined as to match an impedance of the first load (30) with an impedance of the antenna (10) in the passband (2.4 GHz) and the adjacent band (2.4˜2.48 GHz) thereof, and may be designed so that the impedance becomes infinite (open) in the stopband (5 GHz) and the adjacent band (5˜6 GHz) thereof. Here, a magnitude of a reflection coefficient of the first FEM (20) may be determined between 0.9 and 1, and a phase of the reflection coefficient of the first FEM (20) may be determined between minus 50 degree and plus 30 degree.

In addition, the second FEM (25) may be designed so that the impedance (50Ω) is determined as to match an impedance of the second load (35) with an impedance of the antenna (10) in the passband (5 GHz) and the adjacent band (5˜6 GHz) thereof, and may be designed so that the impedance becomes infinite (open) in the stopband (2.4 GHz) and the adjacent band (2.4˜2.48 GHz) thereof. Here, a magnitude of a reflection coefficient of the second FEM (25) may be determined between 0.9 and 1, and a phase of the reflection coefficient of the second FEM (25) may be determined between minus 50 degree and plus 30 degree.

As previously described, the above example is intended to illustrative, and the scope of the present disclosure is not limited in the frequency bands described in an exemplary embodiment. In addition, although two frequency bands are described in an exemplary embodiment of the present disclosure, the actual number of frequency bands may be increased, also as previously described.

According to an exemplary embodiment of the present disclosure, the matching circuits (40˜46) may be implemented in a shape of filter, as circumstances require. That is, for example, each of the matching circuits (40˜46) may be formed as any one of an LPF (Low Pass Filter), an HPF (high pass filter), a BPF (Band Pass Filter), or a BSF (Band Stop Filter). However, the matching circuits (40˜46) may also be eliminated when the impedances and reflection coefficients of the FEMs (20, 25) are ideally implemented.

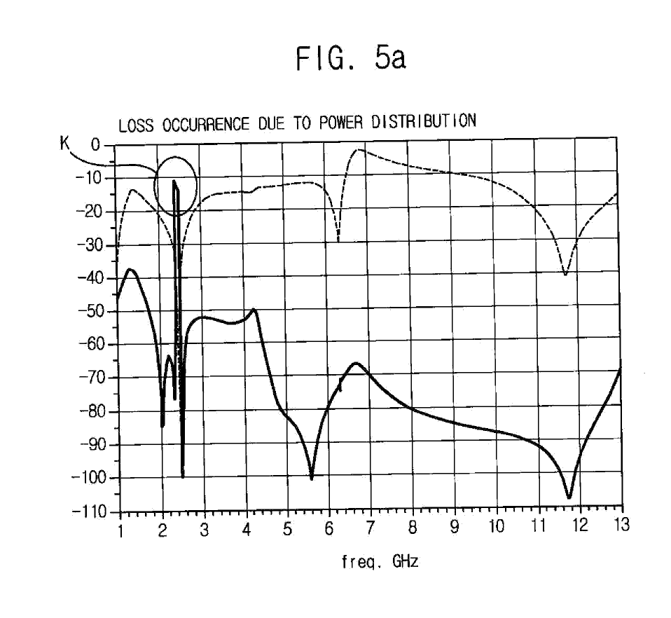

FIG. 4 is a conceptual block diagram illustrating an RF module according to another exemplary embodiment of the present disclosure. An RF module where matching circuits (40, 42, 44, 46) are eliminated from an exemplary embodiment of FIG. 2 of the present disclosure is illustrated in FIG. 4.

That is, the matching circuits (40˜46) may be eliminated when the impedances and reflection coefficients of the FEMs (20, 25) are ideally implemented. In addition, an RF module (1) configured to function as a diplexer according to characteristics of the FEMs (20, 25) may be provided.

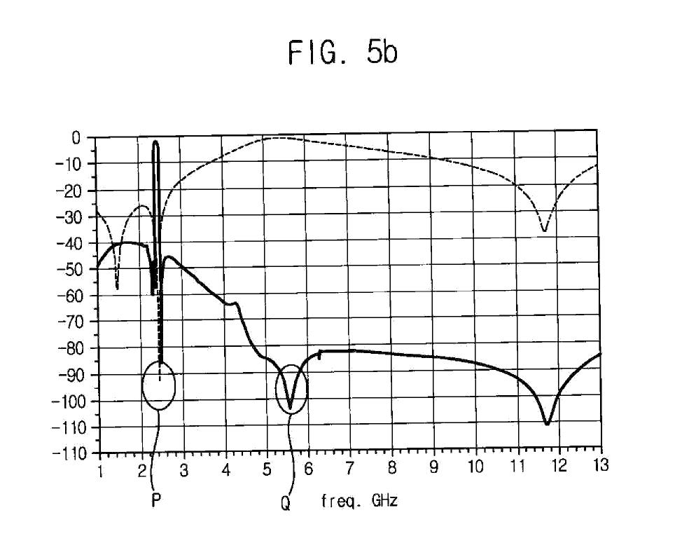

FIGS. 5A and 5B are exemplary views describing implementation characteristics of the present disclosure. FIG. 5A illustrates an example where a diplexer is eliminated from a conventional RF module. FIG. 5B illustrates characteristics of an RF module (1) according to an exemplary embodiment of the present disclosure. Here, the dotted line refers to a circuit characteristic (insertion loss) of a 5 GHz band signal, and the full line refers to a circuit characteristic (insertion loss) of a 2.4 GHz band signal.

Referring to FIG. 5A, a loss due to power distribution occurs, when a diplexer (110) is eliminated from the conventional RF module illustrated in FIG. 1 . That is, it is shown that a branch loss (−10 dB, in ‘K’ region) is generated due to the power distribution, as well as resonances occur in 2.4 GHz and 5 GHz bands.

As illustrated in FIG. 5B, regarding the RF module (1) according to an exemplary embodiment of the present disclosure, it is shown that resonances occur in a first band (‘P’ region) of 2.4 GHz and in a second band (‘Q’ region) of 5 GHz, respectively. In addition, it is also shown that the signals may be delivered without power distribution.

The RF module according to an exemplary embodiment of the present disclosure may be applied to a transmitter/receiver which simultaneously transmits/receives a Wi-Fi signal and a Bluetooth signal, or may be applied to a transmitter/receiver which simultaneously transmits/receives a Wi-Fi signal and a GPS (Global Positioning System) signal. Otherwise, the RF module according to an exemplary embodiment of the present disclosure may be applied to a transmitter/receiver which simultaneously transmits/receives a Wi-Fi signal and, a mobile communication signal (for example, an LTE (Long Term Evolution) signal). That is, the RF module according to an exemplary embodiment of the present disclosure is applicable to a system which transmits/receives signals in different frequency bands, regardless of the type of the bands thereof.

In addition, although an exemplary embodiment of a system having a single antenna is described, and the scope of the present disclosure is not limited hereto. Therefore, the present disclosure may be allied to a MIMO (Multiple-Input, Multiple-Output) system having a plurality of antennas. It is obvious to those skilled in the art that the system as illustrated in FIG. 2 may be respectively provided to each of the plurality of antennas in the MIMO system.

As described in the above, according to an exemplary embodiment of the present disclosure, the entire circuits of the RF module may be simplified and miniaturized, as well as the cost of the whole module may be reduced, by eliminating the diplexer from the RF module at an RF transmit/receive terminal and by eliminating the matching circuits between the antenna and the diplexer and between the diplexer and the FEMs

In addition, according to an exemplary embodiment of the present disclosure, the total path loss can be reduced, by eliminating the diplexer from the RF module at an RF transmit/receive terminal, so as to eliminate loss at the diplexer and the matching circuit.

The abovementioned exemplary embodiments are intended to be illustrative, and not to limit the scope of the claims. Many alternatives, modifications, variations, and equivalents will be apparent to those skilled in the art. The features, structures, methods, and other characteristics of the exemplary embodiments described herein may be combined in various ways to obtain additional and/or alternative exemplary embodiments within an equivalent scope. Therefore, the technical scope of the rights for the present disclosure shall be decided by the claims.

What is claimed is:

1. An RF module comprising:
a first FEM configured to bypass a signal in a first band, and to block a signal in a second band; and
a second FEM configured to block a signal in the first band, and to bypass a signal in the second band.

2. The RF module of claim 1, wherein:
the first FEM transmits the signal in the first band received from an antenna to a first load, and transmits the signal in the first band received from the first load to an antenna, and
the second FEM transmits the signal in the second band received from the antenna to a second load, and transmits the signal in the second band received from the second load to the antenna.

3. The RF module of claim 2, wherein:
the first FEM is designed as to resonate with respect to the signal in the first band, and to have an infinite impedance with respect to the signal in the second band.

4. The RF module of claim 3, wherein:
a magnitude of a reflection coefficient of the first FEM is determined between 0.9 and 1, and
a phase of the reflection coefficient of the first FEM is determined between minus 50 degree and plus 30 degree.

5. The RF module of claim 3, wherein:
the first FEM has an impedance determined so as to match an impedance of the first load with an impedance of the antenna in the first band.

6. The RF module of claim 2, wherein:
the second FEM is designed as to resonate with respect to the signal in the second band, and to have an infinite impedance with respect to the signal in, the first band.

7. The RF module of claim 6, wherein:
a magnitude of a reflection coefficient of the second FEM is determined between 0.9 and 1, and
a phase of the reflection coefficient of the second FEM is determined between minus 50 degree and plus 30 degree.

8. The RF module of claim 6, wherein:
the second FEM has an impedance determined so as to match an impedance of the second load and an impedance of the, antenna in the second band.

9. The RF module of claim 2, wherein:
at least one of the first and the second FEMs is an SPLIT switch configured to separate a transmission signal and a reception signal.

10. The RF module of claim 2, wherein:
at least one of the first and the second FEMs is a duplexer configured to electrically separate a transmission signal and a reception signal.

11. The RF module of claim 2, wherein:
at least one of the first and the second FEMs is an element configured to perform an ON/OFF function with respect to a transmission signal, and to perform an LNA function with respect to a reception signal.

12. The RF module of claim 2, wherein:
at least one of the first and the second FEMs is an element configured to perform an ON/OFF function and an amplification function with respect to a transmission signal, and to perform an LNA function with respect to a reception signal.

13. The RF module of claim 2, further comprising:
a first matching circuit configured to match an impedance of the antenna and an impedance of the first FEM; and
a second matching circuit configured to match an impedance of the antenna and an impedance of the second FEM.

14. The RF module of claim 13, wherein:
each of the first and the second matching circuit is any one of a low pass filter, a high pass filter, a band pass filter, or a band stop filter, respectively.

15. An RF transmitter/receiver comprising:
an antenna configured to receive signals in at least two bands; and
an RF module configured to transmit the signals in at Beast two bands received from the antenna to at least two loads, respectively,
wherein the RF module includes at least two FEMs configured to bypass any one of the signals in at least two bands and to block other signals in remaining bands.

16. The RF transmitter/receiver of claim 15, wherein:
the RF module includes at least two matching circuits configured to match an impedance of the antenna and an impedance of each of the at least two FEMs, respectively.

17. A MIMO (Multiple-Input,-Multiple-Output) system comprising:
a plurality of antennas configured to receive signals in two bands, respectively; and
a plurality of RF modules configured to transmit the signals in two bands respectively received from the plurality of antennas to two loads, respectively,
wherein each of the plurality of RF modules respectively includes:
a first FEM configured to bypass a signal in a first band, and to block a signal in a second band; and
a second FEM configured to block a signal in the first band, and to bypass a signal in the second band.
